(19) United States
(12) Patent Application Publication
(10) Pub. No.: US 2014/0201706 A1
(43) Pub. Date: Jul. 17, 2014

(54) CREATING PLUGGABLE ANALYSIS VIEWPOINTS FOR AN OPTIMIZATION SYSTEM MODEL

(71) Applicant: INTERNATIONAL BUSINESS MACHINES CORPORATION, Armonk, NY (US)

(72) Inventors: David Boaz, Bahan (IL); Lev Greenberg, Haifa (IL); Lior Limonad, Nesher (IL); Nir Mashkif, Ein Carmel (IL); Michael Masin, Haifa (IL); Ran Rinat, Tel Aviv (IL); Aviad Sela, Yokneam (IL)

(73) Assignee: INTERNATIONAL BUSINESS MACHINES CORPORATION, Armonk, NY (US)

(21) Appl. No.: 13/740,284

(22) Filed: Jan. 14, 2013

(51) Int. Cl. G06F 9/44

(52) U.S. Cl. CPC G06F 8/10
USPC 717/104

(57) ABSTRACT

A method of creating a system having pluggable analysis viewpoints over a design space model based on templates for analytical representation of different system aspects, comprising:
a) Ontologically representing each of a plurality of system viewpoints with a subset of the components and classes using attributes and inter-attribute relationships.
b) Automatically creating a unified design space model represented by the design space components according to a plurality of user defined pluggable analysis viewpoints and modeling viewpoints.
c) Automatically generating a design space model derived from a plurality of analysis and modeling viewpoints.
d) Receiving at least one change marked by a user with respect to a certain one of the plurality of analysis and modeling viewpoints.
e) Automatically updating the design space model and the plurality of viewpoint models to reflect the at least one change.
f) Outputting the updated design space model and the plurality of viewpoint models.

### BACKGROUND

The present invention, in some embodiments thereof, relates to creation of an updateable and modular analysis model having multiple viewpoints and, more specifically, but not exclusively, to creation of pluggable analysis viewpoints. These viewpoints define templates for analytical representation of system aspects using a framework employing ontological classification of system components by their attributes.

Systems Engineering governs the design process associated with the development of large-scale products through defining systems and subsystems requirements, their architecture, and critical parameters. As systems complexity increases, analysis simplification techniques are required for exploring feasible, safe, reliable and affordable designs.

There are currently several analysis simplification techniques that are most popular in helping handling the complexity: layering a system design process into several levels of abstraction, separation of concerns, and using automated computerized tools for modeling, optimization and analysis.

By layering a system model in multiple levels of abstraction, a design process is defined as a gradual sequential progression via these abstraction layers where only relevant layers are considered at a time, usually two, where the top layer is considered as the requirement layer from which requirements are extracted for its succeeding dependent lower layer which is the corresponding implementation layer. Each such design step includes a modeling phase and an analysis and optimization phase.

Complementary to levels of abstraction break down, separation of concerns is attained by further splitting the various system elements and their corresponding constraints (in each abstraction layer) into different perspectives called viewpoints. Viewpoints are generated according to interests and allow separation of concerns, for example, domains of expertise and stages in lifecycle. Consequently, a system can be thought of as derived composite contribution of all its viewpoints. Viewpoints are created for groups of elements and selected related constraints which are part of the designed system according to a set of interests. Different viewpoints of a system may include functional requirements, physical architecture, safety, geometry, timing, scenarios, etc. Even though partial interdependence may exist between different viewpoints, viewpoints are usually developed independently by different parties of interests involved in the design process and in most cases using different languages and tools. Furthermore, any viewpoint can serve as a contributing viewpoint for another set of generated models, e.g., for analysis of some system's properties. Consequently, we can expect a hierarchy of system viewpoints and corresponding analysis models.

Current modeling approaches for generating viewpoints are usually based on classification by containment, in which classes are first identified as having a set of contained system components as their members. Classes may be further decomposed into subclasses to have a more specific containment of system components. Classification by containment may result in variance in classes across viewpoints due to differences in concerns, constraints, functionality and interaction with other system components, architectural implementation, development languages and tools which may be local to each of the different viewpoints. The system constantly evolves as each development party analyses and optimizes the design using its own developed viewpoint(s) models and introduces changes and modifications to some viewpoints of the system. Every change or modification in a viewpoint may result in additional changes to adjacent viewpoint models, requiring these models to be updated. Moreover the design process is an iterative one, requiring continuous integration and adaptation. The differences in classification between viewpoints presents a major effort in integrating changes and modifications introduced to the system models and in turn another major effort in updating analysis models derived from all viewpoints.

Automated tools usage is essential to increasing productivity and reducing analysis, design, and development time. The variance in system components structure and viewpoints classification present an obstacle for using automated tools for integrating multiple viewpoints into one unified model and integration is mostly performed manually, presenting a major drawback in the design flow.

Despite partial interdependences between the viewpoints, models for each are usually developed independently. Moreover, in many cases viewpoints models are developed by different parties using different tools and languages. However, the essence of Systems Engineering requires an up to date complete system model in order to find meaningful designs and to make good architectural decisions. Maintaining an up to date system models requires repetitive integration of multiple viewpoints which are mapping between consecutive levels of abstractions and Design Space Exploration. This integration effort of the multiple viewpoints into one unified consistent model has becomes a significant challenge.

### SUMMARY

According to some embodiments of the present invention, there are provided methods, frameworks and computer program products for creation of pluggable analysis viewpoints over an updateable and modular design space model. These analysis viewpoints define templates for analytical representation of different system aspects by using a framework that employs ontological classification of system components by their attributes.

The methods described herein allow for automated and/or controlled maintenance of a unified up to date design space model by adapting changes made by users working with one or more modeling or analysis viewpoint models. As this is an iterative process, once the design space model is updated, the methods described herein allow the propagation of these changes and generation of updated viewpoints as an automatic and/or controlled process.

The present invention, in some embodiments thereof, uses a created updateable design space model prescribed by a plurality of domain perspectives. The proposed framework and method address the challenge of producing analysis templates based on the integrated data from these domain perspectives including the mechanisms required to access it in order to produce correct analysis models. One target usage of the invention relates to industrial Systems Engineering.

The basis for allowing propagation of update of the design space model and generation of updated viewpoints of that system lies within the concept of generalizing system components structure and classification of system components by properties and more specifically ontologically assignment of properties (attributes) to system components.

Generalization through ontological classification of system components by attribute allows separation of system components from their classification in the different viewpoints domains which is heavily dependent on architectural implementation and functionality, thus maintaining uniformity of classification across all domains.

According to some embodiments of the present invention, there is provided a framework for maintaining consistency of system components across all viewpoints models constituting a design space. The framework provides generalization of structuring system components through dedicated ontological attributes assignment, allowing automatic adaptation of changes to the modeling viewpoints, automatic generation of generated analysis models based on analysis viewpoints out of the design space model, and reuse of optimization models.

Using the framework allows automated update of the design space model to adapt changes made to the viewpoints by a user working with one or more of the viewpoint models. Further to that, the framework supports automatic generation of updated analysis models from analysis viewpoints and the updated design space model.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a gradual design process broken down to several abstraction layers, according to some embodiments of the present invention;

FIG. 2a is a schematic illustration of an exemplary conceptual architecture of a design space using an ontology based framework, according to some embodiments of the present invention;

FIG. 2b is a schematic illustration of a second exemplary conceptual architecture of a design space using an ontology based framework, according to some embodiments of the present invention;

FIG. 3 is a schematic illustration of an exemplary framework ontology, according to some embodiments of the present invention;

FIG. 4 is a flow chart which is a flow of an exemplary design process in a design space based on classification by property and supported by ontological framework, according to some embodiments of the present invention;

FIG. 5 is a schematic illustration of an exemplary system implementing a design process based on classification by property and supported by ontological framework, according to some embodiments of the present invention; and

FIG. 6 is a schematic illustration of an exemplary gradually evolving system, according to some embodiments of the present invention.

### DETAILED DESCRIPTION

According to some embodiments of the present invention, there are provided methods, frameworks and computer program products for creation of a plurality of pluggable analysis viewpoints that define templates for analytical representation of different system aspects over an updateable and modular design space model having a plurality of viewpoints by employing generalization and ontological classification of system components by attributes.

The updatable design space model and the automatic generation and update of viewpoints is facilitated through generalization of system components' structure and maintaining uniformity in classification of the system components across the viewpoints. Classification of the generalized system components is done by property and more specifically by dedicated ontological assignment of valued properties (attributes) to system components.

A user analyzes and optimizes the design space model using one or more of analysis viewpoints encapsulating specific concerns. These analysis viewpoints may serve on their own where the analysis is actually executed, or alternatively, contribute to other generated analysis viewpoints. During analysis and optimization the user may introduce changes and modifications to the design. The changes and modifications made by the user need to be integrated back into one or more viewpoints of the system. The viewpoints are updated through addition, removal and/or aggregation of system components and/or through addition, removal and/or aggregation of attributes. Updates and changes to the design space model need to be propagated and adapted across the existing hierarchy of the modeling viewpoints models and the generated analysis viewpoints models. The uniform and generic nature of the design space model and its derived viewpoints enables the use of automated tools for creating and updating the modeling and analysis viewpoints.

Optionally, the design process is an iterative process having multiple iterations of modeling a system followed by analysis and optimization resulting in updated system model that is further optimized and so on.

As aforementioned, popular simplifications techniques for complex system design include layering a system design process into several levels of abstraction, separation of concerns, and using automated computerized tools for modeling, optimization and analysis.

Aspects of the present invention are described below with reference to flowchart illustrations and/or block diagrams of methods, apparatus (systems) and computer program products according to embodiments of the invention.

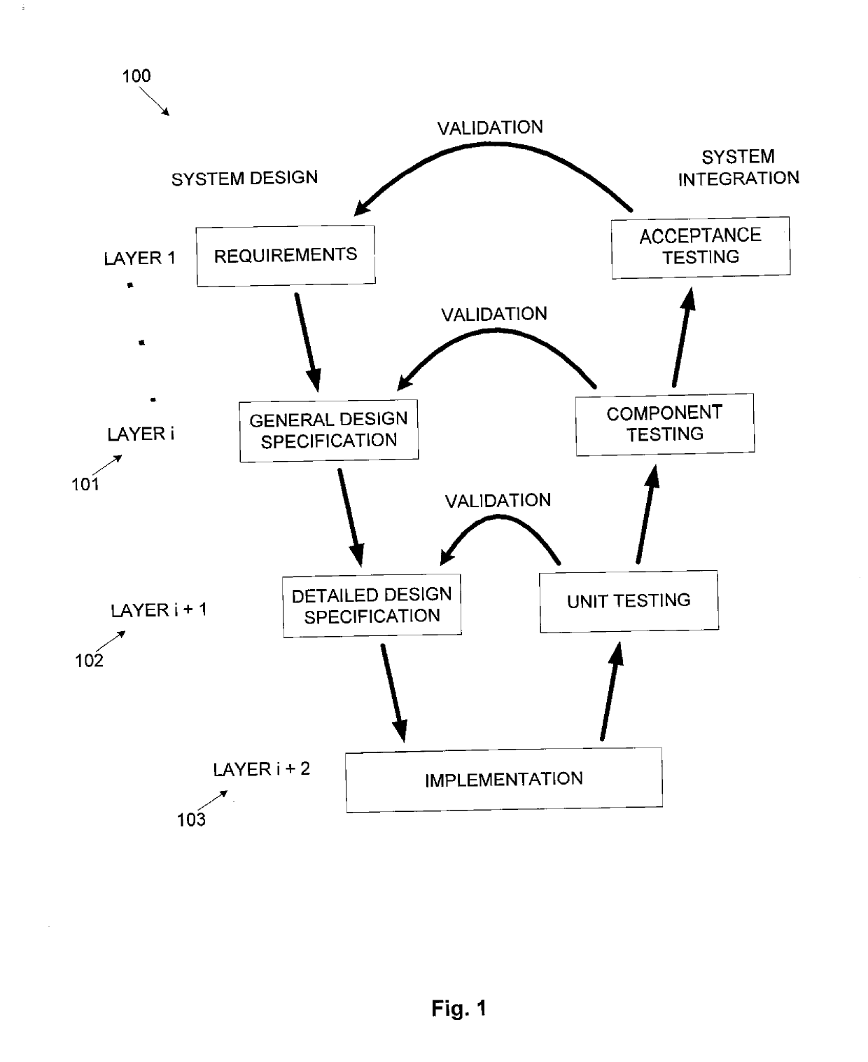

Reference is now made to FIG. 1 which is a schematic illustration of an exemplary gradual design process 100 broken down to several abstraction layers, according to some embodiment of the present invention. Breaking down a system design into multiple abstraction layers allows simplification of the design process which becomes a gradual sequential progression via the abstraction layers. At any point in time during design process 100, only relevant layers of the overall design may be considered, optionally, two layers, LAYER i 101 and LAYER i+1 102. LAYER i 101 is considered requirement layer from which requirements are extracted and imposed on a succeeding lower layer LAYER i+1 102 which is considered implementation layer. Design process 100 may consist of two phases during development of layers LAYER i 101 and LAYER i+1 102, herein referred to as modeling phase and optimization phase. Modeling phase includes development and refinement of the architectural design while optimization phase includes analysis of the architectural design in search of an optimal implementation. Once development is completed for layers LAYER i 101 and LAYER i+1 102, design process 100 gradually moves to the next abstraction layer, where LAYER i+1 102 becomes requirements layer for LAYER i+2 103 which is considered implementation layer. This sequence is repeated though all abstraction layers of the design process 100.

During development in an abstraction layer, viewpoints are developed to further split the system to different perspectives as seen by different parties involved in the design process. The viewpoint models are processed into a design space model which conforms to a generic component structure, namely, the design space ontology. The structure of the design space model includes a complete set of the attributes and inter-attributes that are originally present in the system viewpoints models. Design space components include intrinsic attributes which are considered to be inherent to a component. Design space components may share mutual attributes with one or more other design space components. These intrinsic and mutual attributes correspond to intrinsic or mutual attributes defined in modeling and/or analysis viewpoints. Classes of components are created based on property sets which were processed and represented in the design space rather than the containment of components which were classified in the system viewpoint models.

Optionally, new components evolve during the design process, as two or more components and/or two or more viewpoints are aggregated during modeling and/or optimization phases. New components are created in the design space model by adding and/or removing attributes in their generic structure representation.

More optionally, system components have mutual attributes which result from aggregating two or more components and/or two or more viewpoints and defines the relationship between two or more system components.

More optionally, a system component may belong to one or more classes in the design space model depending on the viewpoint, but the basic structure of all components remains unchanged. Attributes may be added or removed from components through ontological assignment in the appropriate attribute fields.

The ontological classification separates system components from classes and viewpoint models local considerations. Moreover, ontological classification maintains uniform representation of system components across the entire design space.

Implementation of generalized ontological attributes classification across the design space enables the use of automated tools that may dramatically increase efficiency and productivity.

According to some embodiments of the present invention, there is provided a framework for supporting generalization of system components and classification of system components by property, more specifically by valued property, referred to herein as attribute. The framework provides algebraic representation, API and libraries for defining system components, their inter relations, and corresponding axioms about the desired system design. Using this framework allows maintaining uniformity of system components representation across the different viewpoints supporting a unified design space model and allowing for simple and automated adaption of changes and modifications to the design space model through integration of the various viewpoints as well as automated generation and update of the various viewpoints. In addition to that it is possible to generate new viewpoints using two or more existing viewpoints in order to provide a user the ability to analyze and optimize system aspects according to his needs and interests.

Optionally, the framework includes previously developed analysis viewpoints through reusable pluggable libraries allowing reuse in the design process, further reducing design effort, making it more robust and efficient.

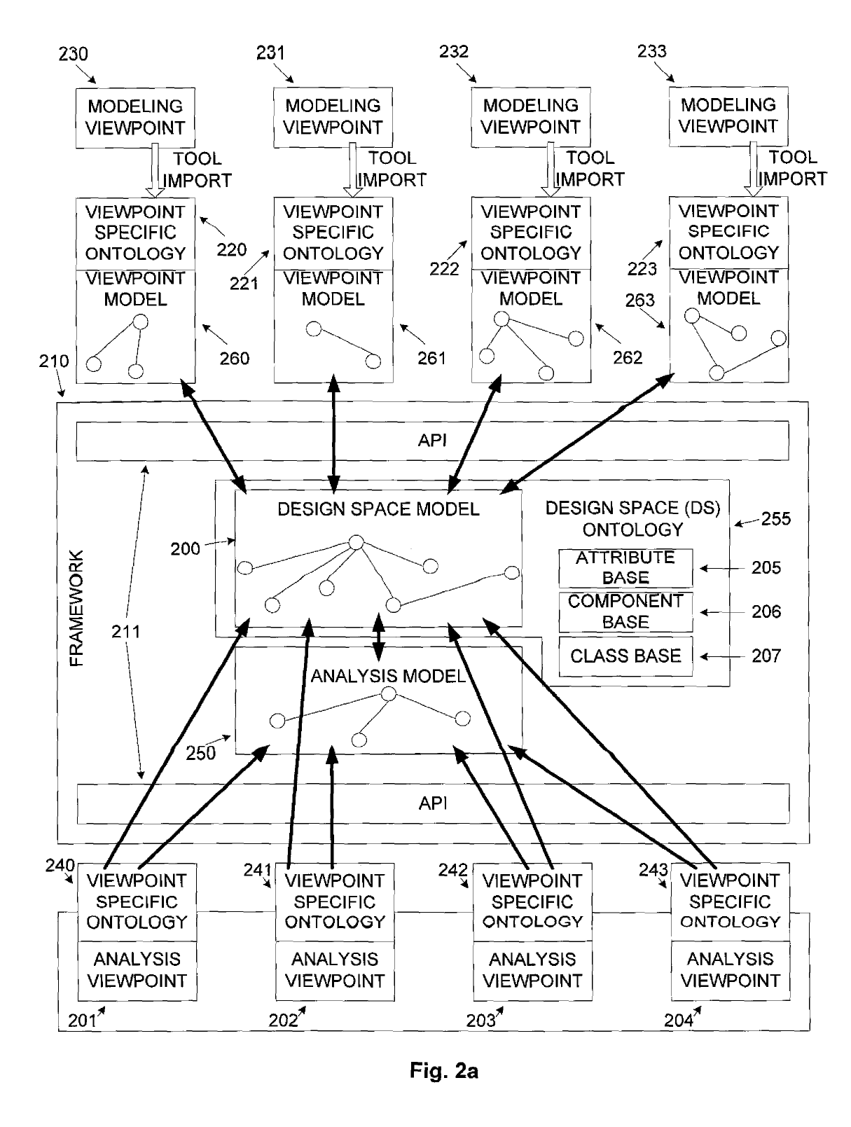

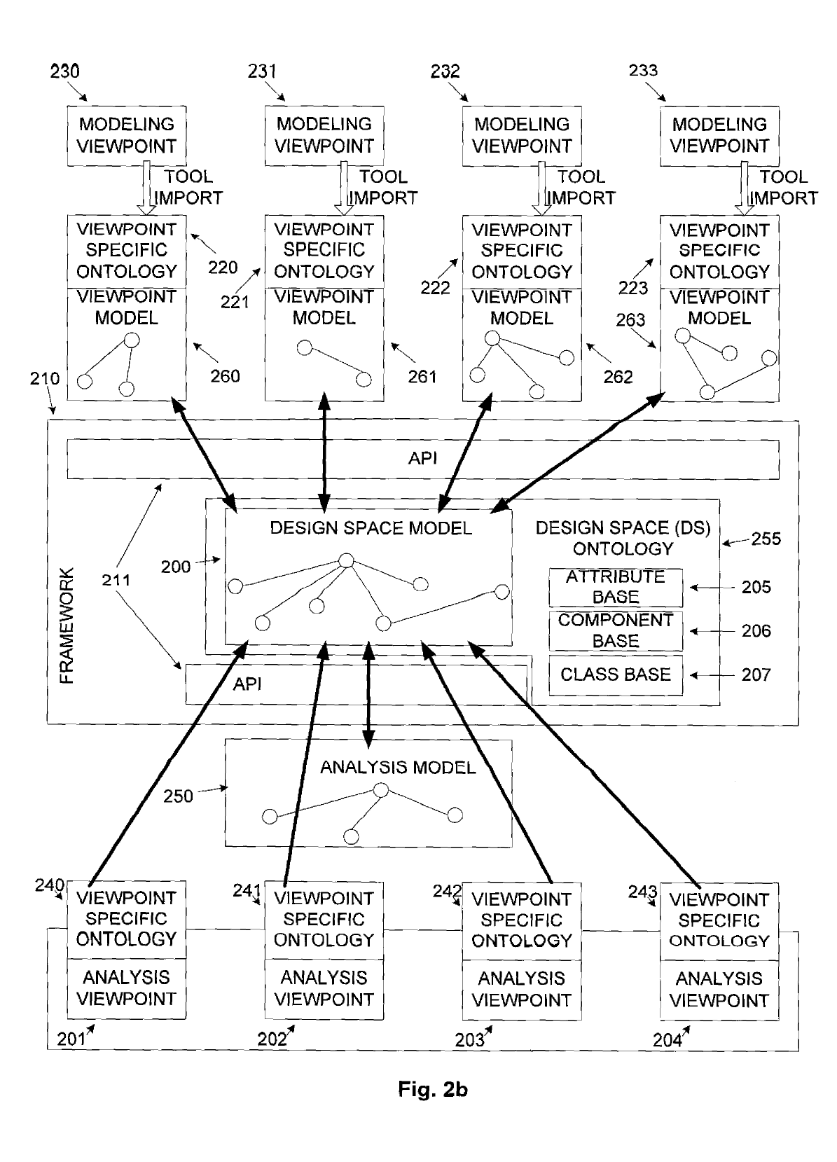

Reference is now made to FIG. 2a which is a schematic illustration of an exemplary conceptual architecture of a design space model using an ontology based design space framework, according to some embodiment of the present invention. Uniformity is maintained across an entire design space as the design space model 200 adheres to its design space ontology 255, modeling viewpoints 230, 231, 232 and 233 each adhere to its corresponding specific ontology 220, 221, 222, and 223, respectively and analysis viewpoints 201, 202, 203 and 204 each adhere to its corresponding specific ontology 240, 241, 242, and 243, respectively. Interaction between the modeling viewpoint 230, 231, 232 and/or 233 and the design space model are done through the use of a framework 210 and an API 211 provided by the framework 210. The same framework 210 and API 211 are used for interacting between the analysis viewpoints 201, 202, 203 and/or 204 and the design space model 200. The unified design space model 200 is gradually inferred and created from the creation of viewpoint models 260, 261, 262, and/or 263 which are created in the modeling viewpoints 230, 231, 232 and/or 233, respectively. The analysis model 250 is created within the framework 210, thus making it fully compliant with the design space model 200 and the design space ontology 255. Aspects of the design as seen from a global system viewpoint can be inquired and/or modified using the framework 210 and the API 211. The modeling viewpoints 230, 231, 232 and 233 are indirectly used for populating the design space model 200 with system components, while the analysis viewpoints 201, 202, 203 and 204 are used for analysis and/or optimization and may impose constraints to the design space model 200. Constraints may also be imposed through ontological axioms 220, 221, 222 and 223 to restrict the design space model 200. The modeling viewpoints 230, 231, 232, and 233 may be generated directly or be derived automatically from the design space model 200. The API 211 is used for creating, inquiring, and/or editing the unified design space model 200 consisting of the system components, derived from the viewpoints models 260, 261, 262 and/or 263. The framework 210 stores the design space model 200 using a property based information technology which represents data resources using attribute base module 207, along with class base module 206 and a component base module 205. Changes and modifications to design space model 200 may be introduced by a user performing analysis and/or optimization using the analysis model 250 created using one or more of the analysis viewpoints 201, 202, 203 and/or 204 and/or using one or more of the modeling viewpoints models 260, 261, 262 and/or 263. Transformations between the analysis viewpoints 201, 202, 203 and/or 204 having their respective ontologies 240, 241, 242 and 243 and the analysis model 250 as well as transformations between the analysis model 250 and the design space model 200 is done using the API 211. Changes in design space model 200 are performed by selecting which system components with which attributes are present in the design. Selection of components, component's attributes and/or component's inter-attributes is a Boolean parameter set/clear operation made in the component module. The selection operation imposes no impact on the algebraic representation of the components, making the algebraic expressions in the analysis viewpoints 201, 202, 203 and/or 204, resilient to changes and modifications in design space model 200 allowing automatic update of the respective analysis models. This process for modification in design space model 200 is possible due to the fact system components are based on ontological attribute assignment supported by the API 211. The design space model is automatically update to integrate the changes and modifications made by the user and the changes to the design space model 200 are adapted to the viewpoints 201, 202, 203 and 204, 230, 231, 232 and 233 which are updated to maintain the complete design space fully up to date and synchronized.

Optionally, the viewpoints 201, 202, 203, 204, 230, 231, 232 and/or 233 are aggregated from two or more other viewpoints.

More optionally, combination of viewpoints 201, 202, 203, 204, 230, 230, 231, 232 and/or 233 yield new system components having new mutual attributes. New components having new attributes conform to the generic component structure. Mutual attributes represent for example, routes and cuts in the design space model 200. New attributes are usually the result of mapping between specific viewpoints however the new attributes are added to the design space model 200 and may be propagated back to the modeling viewpoints 230, 231, 232 and/or 233. Adding the new attributes is essential in order to maintain uniformity of the design space model 200 while maintaining separation between the plurality of viewpoints 201, 202, 203, 204, 230, 231, 232 and 233.

More optionally, the modeling viewpoints 230, 231, 232 and/or 233 may be considered as basic viewpoints that are directly used to populate system components in the design space model 200. In addition to the basic-viewpoints models, the design space model 200 may be influenced by extended-viewpoints which may enrich existing system components with additional attributes or introduce new system components resulting from combination of two or more viewpoints 230, 231, 232 and/or 233. One such example of extended-viewpoints is relational viewpoints which may impose relational attributes describing connections between two or more system components.

More optionally, automated tools are used to import requirements from modeling viewpoints 230, 231, 232 and/or 233 to the unified design space model 200, and similarly from the analysis viewpoints 201, 202, 203 and/or 204 to the unified design space model 200.

More optionally, in case there are relations between components in different modeling viewpoints 230, 231, 232 and 233, they are typically expressed as mutual attributes in the design space model 200. Such relationships may exist between components in modeling viewpoints 230, 231, 232 and/or 233, between components in the analysis viewpoints 201, 202, 203 and/or 204 or between components in modeling viewpoints 230, 231, 232 and/or 233 and components in the analysis viewpoint 201, 202, 203 and/or 204.

More optionally, the analysis model 250 is not created within the framework 210. The analysis model 250 created using the analysis viewpoints 201, 202, 203 and/or 203 is created outside the framework 210, however the analysis model 250 is created according to the framework 210. Transformations between the analysis viewpoints 201, 202, 203 and/or 204 having their respective ontology 240, 241, 242 and 243 and the analysis model 250 as well as transformations between the analysis model 250 and the design space model 200 is done using the API 211.

Reference is now made to FIG. 2b which is a schematic illustration of a second exemplary conceptual architecture of a design space model using an ontology based design space framework, according to some embodiment of the present invention. As shown in this example, the analysis model 250 is created outside the framework 210, however it is created using the analysis viewpoints 201, 202, 203 and/or 204 each having its corresponding ontology 240, 241, 242 and 243 respectively, which are all compliant with the framework 210 and the design space ontology 255. Interaction between the analysis model 250 and the design space model 200 is done using the API 211.

Framework 210 provides functions and services through API 211 that includes a set of operators that are required for the inquiry of all data sets and any related information over which all algebraic expressions in the analysis viewpoints 210, 202, 203 and 204 should operate. All extracted data is constructed and stated according to the unified design space ontology 255. This way, the analysis viewpoints 201, 202, 203 and 204 become unaffected by the various specific ontological structures 220, 221, 222, and 223 underlying the modeling viewpoints 230, 231, 232 and 233. For example, the framework 210 enables combination of two or more viewpoints using operators like “Join” and “Filter”, retrieval of property/component/class using operators like “GetAttributeScope”, “GetProperties”, “GetMutualPropertyScope”, etc.

Optionally, the framework 210 provides adaptation services and operators for multiple uses, for example, converting units when units are expressed differently in different viewpoints 201, 202, 203, 204, 230, 231, 232 and/or 233 and/or adaptation components for connecting components libraries between viewpoints 201, 202, 203, 204, 230, 231, 232 and 233 and/or for synchronizing attributes across viewpoints 201, 202, 203, 204, 230, 231, 232 and/or 233.

More optionally, the framework 210 enables the inclusion of previously developed and verified analysis models available in the analysis viewpoints 201, 202, 203 and/or 204 that may be reused to expedite system design and enhance efficiency and robustness in the design process.

More optionally, the operators available through the API 211 include, for example, the following inquiry and manipulation handlers for the following operations:

add/modify/drop-Class({list of defining attributes})

insert/modify/drop-Component({list of intrinsic and mutual attributes })

insert/drop-Attribute(<name, value>)

link/unlink-Components(comp1name, comp2name, mutualAttribute)
Mutual attributes may be used to denote a composition/decomposition relationship between components link/unlink-Attributes(attribute1, attribute2, link-description).
Attributes may be linked to one another to denote various possession correspondences such as possession precedence criteria and alike.

getLinkedComponents(mutualAttribute)

getAllComponentsWithAttribute(attribute)

getAllClassComponents(class)

getAllComponentAttributes(component)

getIntrinsicComponentAttributes(component)

More optionally, the API 211 includes a set of model transformation operators to facilitate the required correspondence handling between external tool models, modeling and analysis viewpoints, and the unified design space model, for example:

import/export-Modeling/Analysis Viewpoint(toolModel)

manifestViewPointsIntoUnifiedModel({a set of modeling/analysis viewpoints})

publishUnifiedModeltoViewPoints({a set of modeling/analysis viewpoints})

verifyUnifiedModelVsViewpoints({a set of modeling/analysis viewpoints})

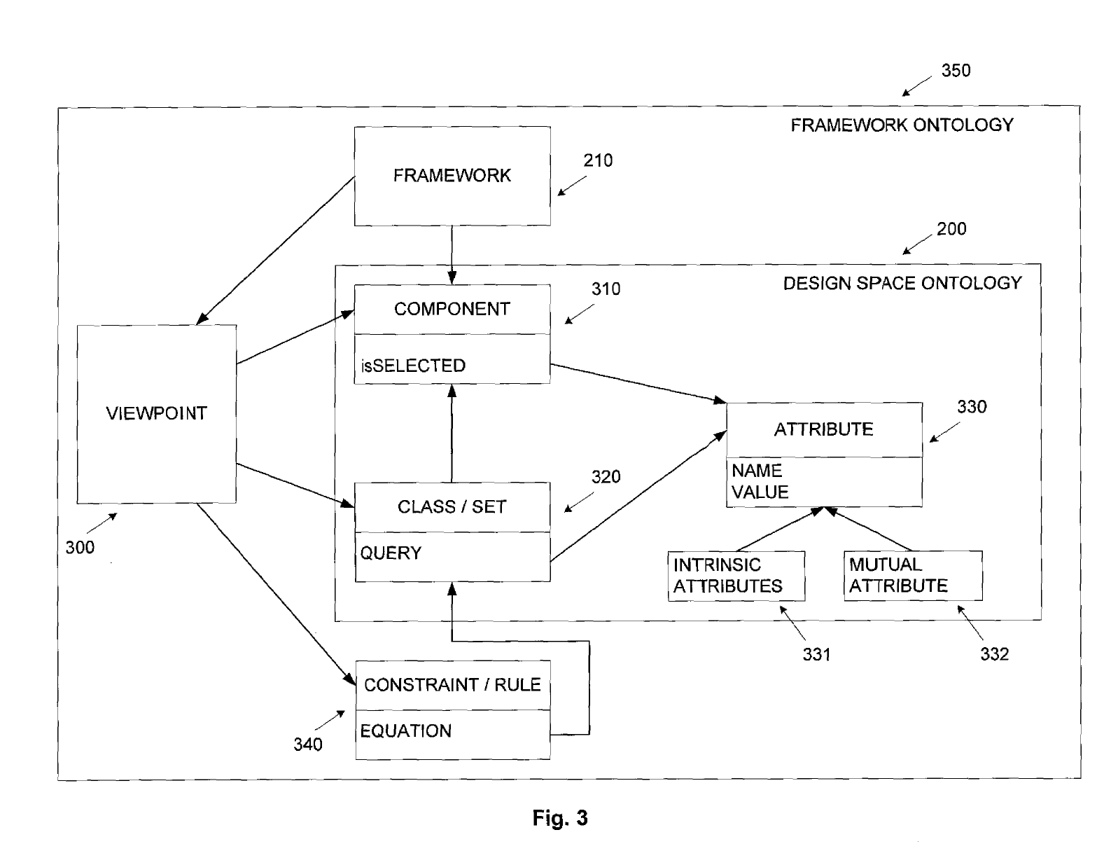

Reference is now made to FIG. 3 which is a schematic illustration of exemplary framework ontology, according to some embodiment of the present invention. The framework 210 is used for constructing system components, classes (or component sets) and viewpoints, through the use of a generic component structure. The underlying basis of framework 210 is an attribute base 205 that includes all attributes and inter-attribute relationships that are possible in the design space model 200. Attributes include intrinsic attributes 331 which are inherent in a component 310. The attribute structures 330, 331 & 332 are managed by the attribute base module 205. The design space model 200 also includes a component base module 206 that holds all the system components (characterized by attributes) which may be included in the design space model 200 and a class base module 206 that holds all classes (characterized by attributes) which may be included in the design space model 200. A class 320 may be constructed by associating the class 320 with a set of attributes 330 from the attribute base 205. The component 310 is structured by ontologically assigning the component 310 with its subset of attributes 330 out of attribute base 205. The Class 320 may be associated with its set of components 310, referred to as the class-extension, through their shared attributes 330. For example, if the class 320 is named “colorful items” and is defined by the single attribute specified as: name=“hasColor” and value=“true”, then any component 310 that is present in the in the component base 205 and includes the attribute name=“hasColor” and value=“true” may be automatically considered as a member of the class 320. A viewpoint 300 may be created by selecting components 310 that are of interest to viewpoint 300 using a select parameter available in each system component 310 as it conforms to the structure of the generic component structure. The framework 210 holds an ontology 350 that may include a reference identifying which viewpoint 300 each component 310 is selected for. This can be implemented as part of the generic component structure storing this reference as an additional parameter in the design space ontology 200. Viewpoint 300 is created using API 211 that is available by framework 210. Viewpoint 300 may impose a constraint 340 on the design space model 200 which is mapped to the class 320 for query in design space model 200 and may result in changes and modification to design space model 200.

Optionally, the attribute base 205 includes mutual attributes 332 which are the result of combining two or more components 310 in one or more viewpoints 300 and represents the relation between two or more of the system components 310.

More optionally, attributes in the attribute base 330 include pre-determined attributes for which value is known and free attributes which are evaluated during the design process.

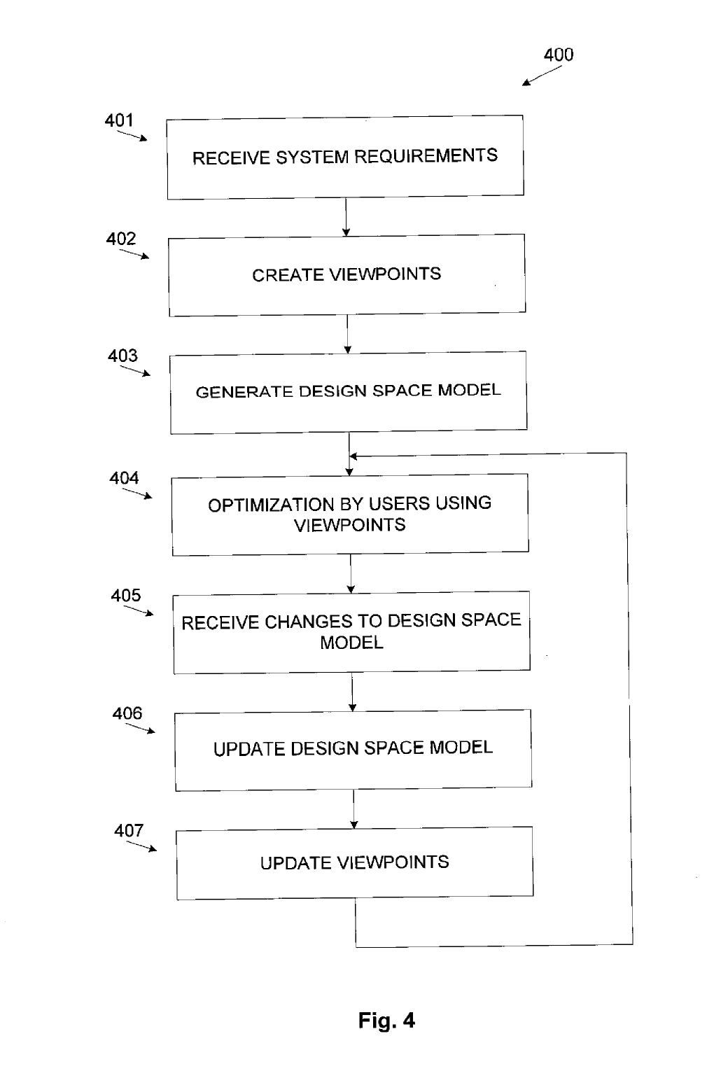

Reference is now made to FIG. 4 which is a flowchart of an exemplary design process based on classification by property and supported by the ontological framework 210, according to some embodiment of the present invention. Design process 400 represents a process that may take place at any phase in the design using any two abstraction layers, where one layer is considered the requirements layer and a lower layer which is considered the architectural implementation layer. As shown in 401, the design process 400 starts with the elicitation of requirements received from one or more parties having different interests for creating one or more modeling and/or analysis viewpoints with the requirements partitioned across different system aspects. Consequently, as shown in 402, one or more viewpoints 201, 202, 203, 204, 230, 231, 232 and/or 233 are created according to the received requirements. As shown in 403, a design space model 200 is then integrated based on the transformation of the representation that adheres to the design space ontology 355. Correspondingly, the design space model 200 is created using components 310 that conform to the structure as defined in the ontological framework 210. As shown in 404, an analysis and optimization session is performed by a user referring to the viewpoints 201, 202, 203, 204, 230, 231, 232 and/or 233 being unified according to the framework ontology 350, thus verifying uniformity across the one or more viewpoints ontology 220, 221, 222, and/or 223. The analysis and optimization session may result in introducing changes and modification to the design space model 200 marked by the user. As shown in 405, optimization driven changes and modifications are received in the design space model 200. As shown in 406, the design space model 200 is updated to adapt the changes and modifications made by the user during the analysis and optimization session. As shown in 407, once the design space model 200 is updated, the viewpoints 201, 202, 203, 204, 230, 231, 232 and/or 233 that are related to the design space model 200 may be automatically updated being subject to the correspondences between the framework ontology 350 and the viewpoints ontology 220, 221, 222, and/or 223.

Optionally, design process 400 requires several iterations to explore and identify an optimal design implementation. Following an optimization session as shown in 404, a modification is performed in design space 200 and the design space model is updated accordingly as shown in 406. Updated viewpoints 201, 202, 203, 204, 230, 231, 232, and 233 are revised from the updated design space model as shown in 407. The process may branch back to 404 where the updated viewpoints 201, 202, 203, 204, 230, 231, 232 and/or 233 may be used for another optimization session. This iterative process may proceed until an optimal implementation is reached or some other completion criterion is met.

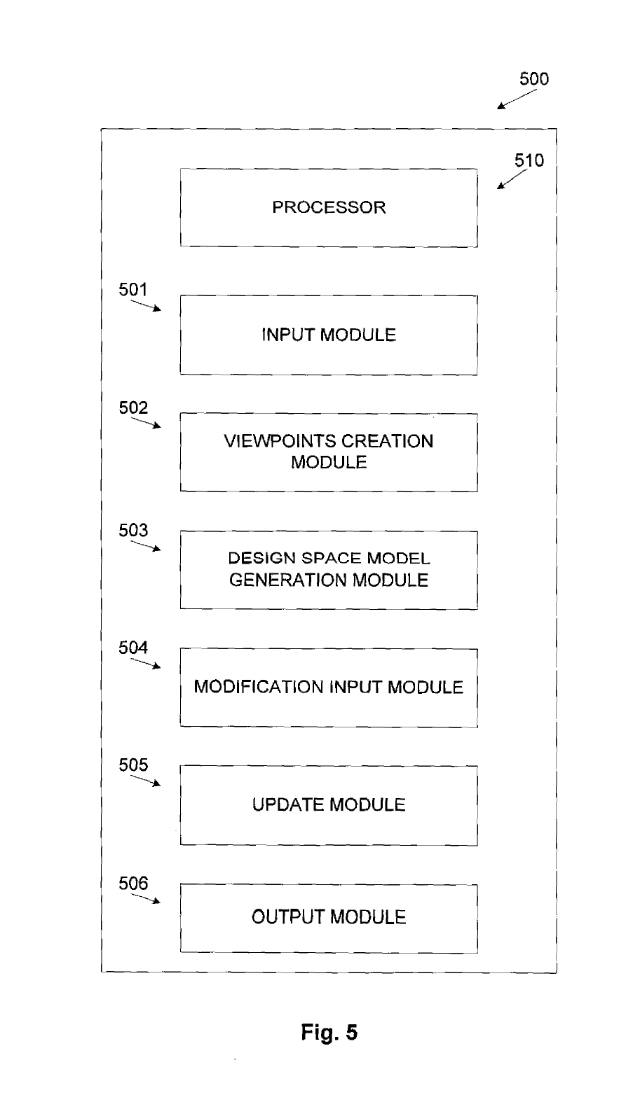

Reference is now made to FIG. 5 which is a schematic illustration of an exemplary system implementing the design process 400, according to some embodiment of the present invention. A system 500 is a processing unit that includes a processor 510 based that is capable of executing program instructions, for example, server, personal computer, etc. The processor 510 executes several software modules, each responsible for a performing part of the overall design process 400. An input module 501 receives user requirements for creation of one or more viewpoints 230, 231, 2323 and/or 233, with the requirements structured according to the viewpoints ontology 220, 221, 222, and/or 223. The user requirements are driven from the input modules 501 to a viewpoints creation module 503 that creates one or more modeling and/or analysis viewpoints 201, 202, 203, 204, 230, 231, 232 and/or 233 according to the received requirements. A design space model generation module 502 creates a derived design space model 200 according to representations received from the viewpoints creation module 501 with respect to one or more of the viewpoints 230, 231, 232 and/or 233. Since the design space model 200 and the viewpoints 201, 202, 203, 204, 230, 231, 232 and 233 are generated according to the framework 210 using API 211, a unified ontology is maintained for the design space model 200. The user that analyzes and optimizes the design space model 200 using the created viewpoints 230, 231, 232 and/or 233 may introduce changes and modifications to the design space model 200. Changes to the design space model are received from the user by a modification input module 504. Modifications to the design space model 200 are driven from the modification input module 504 to an update module 505 which updates the design space model 200 accordingly. The update module 505 also adapts the modifications performed to the design space model for the viewpoints 201, 202, 203, 204, 230, 231, 232 and/or 233. Any change to the design space model 200 is incorporated to all viewpoints 201, 202, 203, 204, 230, 231, 232 and/or 233 in order to maintain a fully up to date unified design space model 200. An output module 506 outputs the up to date design space model 200, analysis viewpoints 201, 202, 203 and/or 204 and/or modeling viewpoints 230, 231, 232 and/or 233.

Optionally, multiple iterations required during the design process 400 are utilized by applying additional modifications in system 500 through the modification input module 505.

According to some embodiments of the present invention, there is provided a computer program product for creation of pluggable analysis viewpoints for a design space model 200 that define templates for analytical representation of different system aspects by employing generalization and ontological classification of system components 310 by attributes 330. The computer program follows the design process 400 and conforms to the framework 210 and API 211, thus maintaining the generic and uniform nature of the design space model 200.

Some embodiments of the present invention, are presented herein by means of an example, however the use of this example does not limit the scope of the present invention in any way. The example is a simple use case of a gradually evolving system that presents the advantages of following a unified ontology design space 200 in comparison to traditional classification by containment.

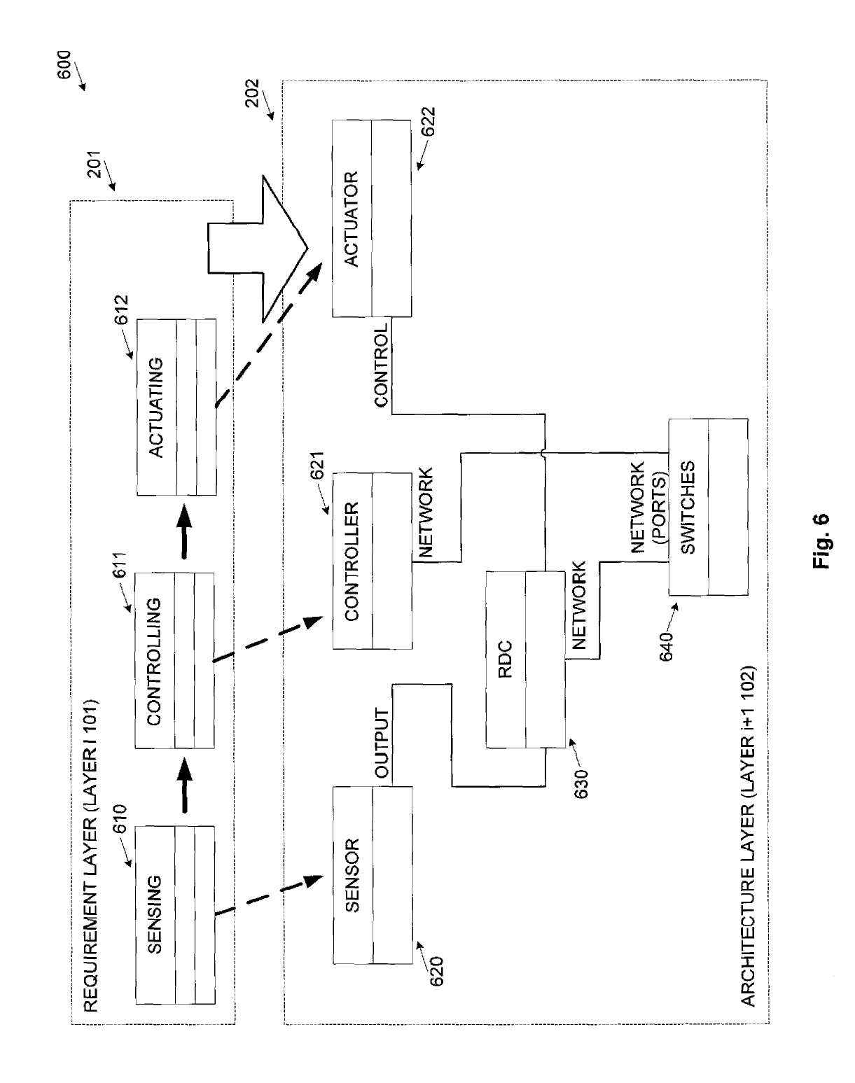

Reference is now made to FIG. 6 which is a schematic illustration of an exemplary system 600, according to some embodiment of the present invention. Requirement layer 101 consists of three system functions, sensing 610, controlling 611 and actuating 612. In addition the requirement layer 101 includes two connection paths, sensing 610 as input to controlling 611 and controlling 611 as input for actuating 612. The architecture layer 102 is implemented through five component types, sensors 220, controllers 621, actuators 622, RDCs (Remote Data Concentrator) 623 and switches 624. The objective of the use case example is to describe an optimization process aimed to minimize system cost while maintaining overall system weight below a pre-determined threshold.

In the example, employing the approach of classification by containment, each component type (class) is defined by a different set of attributes. Additional information for the components contained in the classes is available in component libraries referred to as catalogs. Even though different classes may be defined by different sets of attributes, in this example, all classes have cost and weight attributes. Equation 1 below is an algebraic expression extracted from an optimization model viewpoint and describes total system cost:

$$Equation 1$$

$$totalCost = \text{?} ( j ∈ SensorTypes ) \text{?} \text{?} ( i ∈ Sensors ) \text{?} [ SensorType [ j ] . \\ Cost * sensor [ i ] [ j ] □ + … + \\ \text{?} \text{indicates text missing or illegible when filed} \qquad$$

Equation 1 employs objectives, parameters, sets, variables, and constraints where SensorsType, Sensor, SwitcheType, Switches are sets of system components included in the optimization model viewpoint. SensorType and SwitcheType are known parameters retrieved from catalogs while sensor[i][j] and switch [i][j] are Boolean decision variables identifying the components that are included in the system architectural implementation. The variable totalCost is a continuous decision variable representing the overall system costs and comprises the costs of system components which are included in the system architectural implementation. A mapping constraint is imposed through equation 2 below to ensure every sensing function in the system is mapped to a sensing component.

### Equation 2:

Where sensing2sensor[l][i][j] is a mapping Boolean decision variable. Components population of elements of all sets and the optimization model in general should reflect the actual data defined in all engineering models and stored catalogs.

As the design evolves modifications may be introduced to the optimization model. The design space model 200 may evolve as a result of changes in one or more of the modeling viewpoints 230, 231, 232, and/or 233, for example different types of sensors 620 may be required, thermal sensors and volume sensors, each sensor 620 having its own attributes and its own catalog of available sensor types. As a result of such changes, Equation 1 above for calculating totalCost is updated to reflect the change as described in Equation 3 below:

$$totalCost = {Σ}_{i} ( j ∈ ThemalSensorTypes ) \text{?} ThermalSensorType [ j ] . C \text{?} {\sum }_{j ∈ SwitchTypes}^{ } {\sum }_{i ∈ Switchs}^{ } SwitchType [ j ] . Cost * switch [ i ] [ j ] \\ \text{?} \text{indicates text missing or illegible when filed} \qquad Equation 3$$

The design space model 200 may further evolve as a user introduces another modification to one or more of the viewpoints 230, 231, 232 and/or 233, for example adding a new cable component with corresponding type catalog information. Equation 3 above for calculating totalCost has to be updated again to reflect the new change in costs and weight as described in Equation 4 below. In addition a second consequent may be the geometrical layout of the network specified in a new geometrical viewpoint which may contain two aspects: compartments and links between compartments. Compartments are identified by location coordinates while links are identified with a Length attribute. The architectural implementation as structured using the geometrical viewpoint is taken into account by the optimization model and a new index is added to realize the new geometrical variable. This change implies that at least some existing equations have to be updated to include the new index.

$$Equation 4$$

$$totalCost = \text{?} ( j ∈ SensorTypes ) \text{?} \text{?} ( i ∈ Sensors ) \text{?} \text{?} ( K ∈ Compartments ) \text{?} □ SensorType [ j ] . C \text{?} \\ \text{?} \text{indicates text missing or illegible when filed} \qquad$$

Another change to the optimization model may be inflicted by a safety requirement for redundancy. To meet the redundancy requirements the user may have to include several redundancy channels in the design, further changing the design space model 200. Equation 5 below describes the mapping of redundancy functions to possible implementation options.

$${\sum }_{j ∈ SensorTypes}^{ } {\sum }_{i ∈ Sensors}^{ } sensing2sensor [ l ] [ r ] [ i ] [ j ] = redundancyChannels [ l ] [ r ] \\ ∀ l ∈ SensingFunctions , \\ r ∈ RedundancyChannels \qquad Equation 5$$

Where RedundancyChannels is a set of possible redundancies and RedundancyChannels[l][r] is a Boolean decision variable for finding the optimal redundancy option.

As seen through the use case, a change in one or more of the viewpoints 230, 231, 232 and/or 233 may lead to changes in other viewpoints 230, 231, 232 and/or 233. Furthermore, as there is no consistency between classes and viewpoints, the ability to use automated tools is very limited.

Classification by property allows employment of a unified ontology in the design space 200 by deriving the design space model from the various modeling viewpoints 230, 231, 232, and 233, transforming all viewpoint representations into a unified design space model 200 that is constructed according to the unified design space ontology 355. The use of the ontology based framework 210 enables uniformity across the entire design space model 200 and enables the extraction of data-sets and information that is referred to in the analysis viewpoints 201, 202, 203 and/or 204. Through this uniformity the limitations as presented in the use case may be overcome. Framework 210 provides operators for retrieving components 300 that are present (through their select field) in the unified design space model 200. Equation 6 below presents the calculation of totalCost:

$$totalCost = {\sum }_{j ∈ Scope ( Cost , isContainedIn ( i )}^{ } isSelected ( i ) * Cost ( j ) \qquad Equation 6$$

Where isContainedIn(i) is a mutual attribute describing the relation between two or more system components, utilizing the API 211 operator getLinkedComponents(mutualAttribute) where the mutualAttribute is used to denote decomposition Scope is a straightforward utilization of the getAllComponents(attribute) operator available in the API 211 which identifies all system components having the attribute provided by Scope as parameters. The algebraic expression of totalCost is now independent of changes in particular viewpoints' ontology 220, 221, 222, and/or 223 inflicted by the user. Mapping viewpoints may add mutual properties between requirements and system components describing potential mapping of system components to requirements using Boolean decision variables while maintaining resilience to changes to the design space model 200. Equation 7 below describes an exemplary mapping of system components to requirements.

$$\text{?} \\ Element ) \\ \text{?} \text{indicates text missing or illegible when filed} \qquad Equation 7$$

Where isMapped[i][j] (i stands for requirementsElement and j stands for architectureElement) represents the components that potentially fulfill the mapping of architecture components to requirements. Such mapping is designated by a mutual property after being produced utilizing the link-Components(architecture comp, requirement comp, mutualAttribute) operator that is available in the API 211. The equation ensures correct mapping of system components to requirements that is evolving as viewpoints may introduce changes to the design space model 200 without changing the algebraic expressions used to describe mapping.

As aforementioned new viewpoints may be automatically imported into the design space model 200, for example, a Resource viewpoint that is used for checking if an overall number of system components is exceeded in the design space model 200 after granting the requests made by the requirements. Equation 8 below provides an algebraic expression that may be used for making such a check:

$$dseCapacity ( i ) ( j ) \geq {\sum }_{k ∈ Scope ( dseRequests ( i ) )} isMapped ( i ) ( k ) * dseRequests ( i ) ( k ) \qquad Equation 8$$

As is shown throughout the use case, performing modeling, analysis and optimization using viewpoints 230, 231, 232 and 233 (each having its own ontology 220, 221, 222, and 223 and maintaining uniformity across the design space 200) allows the algebraic expressions to remain resilient to design space model 200 evolution.

1. A computerized method of creating a plurality of pluggable analysis viewpoints, comprising:
providing a plurality of templates for analytical representation of a plurality of system aspects;
ontologically representing each of a plurality of system components with a subset of a plurality of attributes and inter-attribute relationships to indicate links between components;
automatically creating a plurality of modeling and analysis viewpoints of a unified design space model according to a plurality of user defined requirements, wherein said plurality of modeling and analysis viewpoints is created in accordance with a framework;
automatically deriving said unified design space model represented by said plurality of system components from at least one of said plurality of modeling and analysis viewpoints, wherein said unified design space model is created in accordance with a framework;
receiving at least one change marked by a user with respect to a certain viewpoint of said plurality of modeling and analysis viewpoints;
automatically updating said unified design space model and said plurality of modeling and analysis viewpoints to reflect said at least one change; and
outputting said updated design space model and said plurality of modeling and analysis viewpoints.

2. The method of claim 1, wherein inter-attribute relationships indicate links between two or more of said plurality of system components.

3. The method of claim 1, further comprising said plurality of templates includes a generic system component structure which includes said plurality of attributes and inter-attribute relationships.

4. The method of claim 1, further comprising ontologically representing a plurality of system components classes, wherein each of said plurality of classes is defined by a subset of said plurality of attributes and inter-attributes and contains at least one of said plurality of system components having said subset of said plurality of attributes and inter-attributes.

5. The method of claim 1, further comprising said plurality of analysis viewpoints is pluggable for reuse in a plurality of design space models.

6. The method of claim 1, further comprising creating a plurality of relational viewpoints, each by combining at least two of said plurality of modeling viewpoints.

7. The method of claim 3, wherein said generic system component structure includes a plurality of intrinsic attributes and a plurality of mutual attributes, wherein said plurality of mutual attributes is created during import of one or more of said plurality of modeling and analysis viewpoints.

8. The method of claim 7, further comprising said plurality of mutual attributes is created during combination of at least two of said plurality of modeling and analysis viewpoints.

9. The method of claim 7, further comprising said plurality of mutual attributes is updated for said plurality of system components in said plurality of modeling and analysis viewpoints.

10. The method of claim 1, wherein said plurality of system components adheres to said generic component structure.

11. The method of claim 1, further comprising receiving at least one change to at least one of said plurality of modeling viewpoints and automatically updating said unified design space model and said plurality of analysis viewpoints.

12. The method of claim 1, further comprising receiving at least one change to at least one of said plurality of analysis viewpoints and automatically updating said unified design space model and said plurality of modeling viewpoints.

13. The method of claim 1, wherein said receiving at least one change, said automatically updating and said outputting operations are part of an iterative process, said operations are repeated during each iteration of a plurality of iterations.

14. A system for creation of a plurality of pluggable analysis viewpoints, comprising:
a processor;
an input module which receives a plurality of requirements from a user for creation of a plurality of modeling and analysis viewpoints;
a viewpoints creation module which creates, using said processor, a plurality of modeling and analysis viewpoints, wherein said plurality of modeling and analysis viewpoints is created in accordance with a framework;
a system integration module which generates, using said processor, a design space model using said plurality of system components which are derived from said plurality of modeling and analysis viewpoints, wherein said design space model is created in accordance with said framework;
a modification input module which receives at least one change marked by said user with respect to a certain viewpoint of said plurality of modeling and analysis viewpoints;
an update module which updates said unified design space model and said plurality of viewpoints to reflect said at least one change; and
an output module which outputs said updated design space model and said plurality of viewpoints.

15. (canceled)

16. The system of claim 14, wherein said framework provides algebraic representation of a plurality of system components by an ontological assignment of a plurality of attributes and inter-attribute relationships between a plurality of said system components.

17. The system of claim 16, further comprising said framework provides application programming interface (API), libraries of pluggable analysis viewpoints and services supporting automatic generation of said design space model and automatic adaptation of said plurality of changes to said plurality of viewpoints.

18. The system of claim 17, further comprising said API provides operators for creating, aggregating and synchronizing said plurality of viewpoints.

19. A computer program product for creating a plurality of pluggable analysis viewpoints, comprising:
a computer readable storage medium;
first program instructions to receive requirements from a user and create a plurality of modeling viewpoints and analysis viewpoints in accordance with a framework, wherein said plurality of modeling and analysis viewpoints is represented with a subset of a plurality of system components;
second program instructions to generate a design space model using said plurality of system components which are derived from said plurality of modeling and analysis viewpoints in accordance with said framework;
third program instructions to receive at least one change marked by a user with respect to a certain viewpoint of said plurality of viewpoints;
fourth program instructions to update said design space model and said plurality of viewpoints to reflect said at least one change; and
fifth program instructions to output said updated design space model and said plurality of viewpoints;
wherein said first, second, third, fourth and fifth program instructions are stored on said computer readable storage medium.

20. (canceled)

21. The computer program product of claim 19, wherein said framework defines templates for analytical representation of a plurality of system aspects each represented by a plurality of algebraic representations, each having variable and parameter domains being associated with a plurality of system components according to a plurality of user defined requirements.

22. The computer program product of claim 19, said framework provides algebraic representation of a plurality of system components by an ontological assignment of a plurality of attributes and inter-attribute relationships between a plurality of said system components.

23. The computer program product of claim 19, further comprising creation of a plurality of relational modeling viewpoints, each by combination of at least two of said plurality of modeling viewpoints.

24. The computer program product of claim 19, further comprising creation of a plurality of additional analysis viewpoints, each by combination of at least two of said plurality of analysis viewpoints.

25. The computer program product of claim 19, further comprising reception of a plurality of changes to said plurality of modeling viewpoints and update of said design space model and said plurality of analysis viewpoints.

26. The computer program product of claim 19, further comprising reception of a plurality of changes to said plurality of analysis viewpoints and update of said design space model and said plurality of modeling viewpoints.

27. The computer program product of claim 19, wherein said first, second, third, fourth and fifth program instructions conform to a framework that supports creation of a plurality of pluggable analysis viewpoints.
